(19) United States
(12) Patent Application Publication
(10) Pub. No.: US 2024/0253269 A1
(43) Pub. Date: Aug. 1, 2024

(54) Method for Manufacturing Toilet Blank, and Toilet Blank

(71) Applicants: LIXIL (China) Investment Co., Ltd., Shanghai (CN); LIXIL AS SANITARY MANUFACTURING (SHANGHAI) CO., LTD, SHANGHAI (CN)

(72) Inventors: Zhongde Fan, Shanghai (CN); Yongze Liu, Shanghai (CN); Miaogen Shen, Shanghai (CN); Yulin Li, Shanghai (CN); Xiaolong He, Shanghai (CN); FengFeng Tuo, Shanghai (CN); Wenbin Hu

(73) Assignees: LIXIL (China) Investment Co., Ltd., Shanghai (CN); LIXIL AS SANITARY MANUFACTURING (SHANGHAI) CO., LTD, SHANGHAI (CN)

(21) Appl. No.: 18/281,006

(22) PCT Filed: Mar. 7, 2022
(86) PCT No.: PCT/CN2022/079471

§ 371 Date: Apr. 8, 2024

(30) Foreign Application Priority Data
Mar. 11, 2021 (CN) 202110263921.7

(51) Int. Cl. B28B 1/14; B28B 1/00; B28B 13/06; E03D 11/02

(52) U.S. Cl. CPC B28B 1/14; B28B 1/002; B28B 13/06; E03D 11/02

(57) ABSTRACT

The present invention relates to a method for manufacturing a toilet blank. The manufacturing method includes the following steps: a grouting step: producing a seat blank, an inner container blank and a main body blank; a first demolding step: demolding a part of a main body mold, a part of an inner container mold and a part of a seat mold; a first bonding step: bonding a first bonding surface of the inner container blank and a bonding surface of the main body blank to each other; a second demolding step: demolding another part of the inner container mold from the inner container blank; a second bonding step: bonding a bonding surface of the seat blank and a second bonding surface of the inner container blank to each other, and a third demolding step: demolding demolded parts of the seat mold, the inner container mold and the main body mold from a bonded toilet blank. By bonding the blanks to each other with parts of the molds not demolded, the contact of an operator with the blanks is reduced during bonding, and the blanks can be accurately located relative to each other using the parts of the molds.

### TECHNICAL FIELD

The present invention relates to a method for manufacturing a toilet blank, and a toilet blank manufactured by same.

### RELATED ART

With continuous development of the bathroom industry and people's pursuit of increasingly high quality of life, toilets have become an indispensable necessity. Given such a huge market demand, the currently top priority of research and development of toilets is improving the production efficiency of toilet blanks and improving the product quality.

The traditional toilet blank is formed by grouting in an integral mold, but such a traditional mode takes a long time and has low efficiency, high labor intensity, and low degree of automation in manufacturing a toilet blank, and the mold is difficult to clean. To solve the above problems, currently, a method for producing a toilet blank (also known as a toilet finished green body) with a split structure is commonly used in the prior art.

In the current split production process of a toilet blank, a toilet blank is usually formed by at least five blanks, and then the toilet blank is fired into a ceramic body of a toilet in a firing device. Due to the limitations of the structure and production process of the blanks, the processes are cumbersome, and the efficiency is low, and the toilet blank formed by related technologies is not sufficient in structural strength. In addition, since the toilet blank includes at least five parts, at least five or more molds are correspondingly used, and the processing cost is high, which is not conducive to large-scale production.

In addition, there is currently a process of bonding three parts, namely a seat blank, an inner container blank, and a shell blank into a toilet blank, to reduce the number of molds and bonding processes used. However, the methods for manufacturing toilet blanks in the prior art still have the problem of difficulties in locating inevitably caused by operations during bonding, which leads to difficulties in meeting requirements for high-precision blanks. Moreover, the manufacturing methods in the prior art still have the problem of high scrap rate caused by contact of an operator with the fragile blanks.

For this reason, there is always a demand in the technical field of toilet blank manufacturing for producing high-precision blanks at low costs while lowering the scrap rate of clay blanks.

### SUMMARY OF THE INVENTION

In order to solve the above problems, the present invention provides a method for manufacturing a toilet blank. The manufacturing method includes the following steps: a grouting step: grouting a seat mold, an inner container mold, and a main body mold independent of each other respectively to produce a seat blank, an inner container blank, and a main body blank; a first demolding step: demolding a part of the main body mold from the main body blank to expose a bonding surface of the main body blank; demolding a part of the inner container mold from the inner container blank to expose a first bonding surface of the inner container blank; and demolding a part of the seat mold from the seat blank to expose a bonding surface of the seat blank, a first bonding step: placing the inner container mold on the main body mold to bond the first bonding surface of the inner container blank and the bonding surface of the main body blank to each other; a second demolding step: demolding another part of the inner container mold from the inner container blank to expose a second bonding surface of the inner container blank; a second bonding step: placing the seat mold on the inner container mold to bond the bonding surface of the seat blank and the second bonding surface of the inner container blank to each other; and a third demolding step: demolding non-demolded parts of the seat mold, the inner container mold, and the main body mold from a bonded toilet blank. The sub-steps in the first demolding step can be performed in any order, and after the first demolding step is performed, the first bonding step, the second demolding step, the second bonding step, and the third demolding step are sequentially performed.

By bonding the blanks to each other with parts of the molds not demolded, the contact of an operator with the blanks is reduced during bonding, thereby lowering the scrap rate of the blanks caused by contact. In addition, since the blanks are not completely demolded during bonding, the blanks can be accurately located relative to each other using the remaining parts of the molds, thereby improving the bonding effect and lowering the rework rate.

Preferably, in the first demolding step, an upper mold of the main body mold may be demolded from the main body blank, a bottom mold of the inner container mold may be demolded from the inner container blank, and a bottom mold of the seat mold may be demolded from the seat blank.

By demolding only the upper mold of the main body mold and the bottom molds of the inner container mold and the seat mold in the first demolding step, it is easy to make the bonding surfaces of the blanks to be bonded face each other, thus facilitating operations of a subsequent bonding process.

Favorably, the third demolding step may include: demolding an upper mold of the seat mold from the seat blank; and demolding the remaining molds of the main body mold from the main body blank.

In the third demolding step, there may be additional process steps between two sub-steps (or not if the two sub-steps exist in sequence) to improve the flexibility in manufacturing the toilet blank. Especially, if the main body mold is demolded last, the overall stability of the blank can be ensured, and the product yield can be improved.

More preferably, in the first bonding step, before the inner container blank and the main body blank are bonded to each other, the relative position between the inner container blank and the main body blank may be located using the non-demolded part of the inner container mold and the non-demolded part of the main body mold.

By using the inner container mold and the main body mold to locate the inner container blank and the main body blank, it is conducive to accurately locating the two, thereby improving the reliability of the bonding process.

More preferably, in the second bonding step, before the inner container blank and the seat blank are bonded to each other, the relative position between the inner container blank and the seat blank may be located using the non-demolded part of the seat mold and the non-demolded part of the main body mold.

By using the seat mold and the main body mold to locate the seat blank and the inner container blank (already bonded to the main body blank), it is conducive to accurately locating the seat blank and the inner container blank, thereby improving the reliability of the bonding process.

In an especially favorable embodiment, the main body mold at least includes an upper mold and a side mold, and in the first bonding step and the second bonding step, the relative position between the inner container blank and the main body blank, as well as the relative position between the inner container blank and the seat blank may be located using the side mold of the main body mold.

By providing the main body mold with the side mold, mold positions for locating may be conveniently provided, e.g., a plane facing up, such that the relative locating accuracy can be improved when the blanks are bonded to each other.

Especially, a first locating structure may be arranged on the side mold of the main body mold, and a second locating structure and a third locating structure that can match the first locating structure in shape may be arranged on an upper mold of the inner container mold and the upper mold of the seat mold respectively.

By the connection or clamping between the locating structures matched in shape, the blanks can be accurately located easily during bonding, thereby improving the manufacturing quality of the toilet blank.

For example, the first locating structure may include at least one locating hole, and the second locating structure and the third locating structure may include at least one locating detent corresponding to the at least one locating hole.

By using a simple arrangement of holes and detents, the molds are simplified in design, the locating accuracy is improved, and operator errors are reduced.

Preferably, between the sub-steps of the third demolding step, holes may be drilled on the toilet blank.

Before the non-demolded part of the main body mold is demolded, there may be additional process steps to improve the flexibility in manufacturing the toilet blank to meet various user requirements.

Finally, the present invention further relates to a toilet blank manufactured by any of the aforementioned manufacturing methods.

### BRIEF DESCRIPTION OF THE DRAWINGS

It should be noted that the drawings referred to are not all drawn to scale, but can be expanded to illustrate various aspects of the present invention, and in this regard, the drawings should not be interpreted as restrictive.

FIG. 1A illustrates an exemplary stereoscopic view of a seat blank according to an embodiment of the present invention.

FIG. 1B illustrates an exemplary stereoscopic view of an inner container blank according to an embodiment of the present invention.

FIG. 1C illustrates an exemplary stereoscopic view of a main body blank according to an embodiment of the present invention.

FIG. 2A illustrates an exemplary stereoscopic view of a seat mold according to an embodiment of the present invention, with mold parts of the seat mold closed together.

FIG. 2B illustrates an exemplary stereoscopic view of an inner container mold according to an embodiment of the present invention, with mold parts of the inner container mold closed together.

FIG. 2C illustrates an exemplary stereoscopic view of a main body mold according to an embodiment of the present invention, with upper, lower, left, and right mold parts of the main body mold closed together.

FIG. 3A illustrates an exemplary stereoscopic view of a seat mold according to an embodiment of the present invention, with mold parts of the seat mold opened.

FIG. 3B illustrates an exemplary stereoscopic view of an inner container mold according to an embodiment of the present invention, with mold parts of the inner container mold opened.

FIG. 3C illustrates an exemplary stereoscopic view of a main body mold according to an embodiment of the present invention, with mold parts of the main body mold opened.

FIG. 4 illustrates an exemplary exploded stereoscopic view of a toilet blank according to an embodiment of the present invention, showing the relative positional relationship between a seat blank, an inner container blank, and a main body blank.

FIG. 5A illustrates an exemplary bottom stereoscopic view of a seat blank with a seat mold according to an embodiment of the present invention, showing a bonding surface of the seat blank.

FIG. 5B illustrates an exemplary bottom stereoscopic view of an inner container blank with an inner container mold according to an embodiment of the present invention, showing a first bonding surface of the inner container blank.

FIG. 5C illustrates an exemplary top stereoscopic view of a main body blank with a main body mold according to an embodiment of the present invention, showing a bonding surface of the main body blank.

FIG. 6A illustrates an exemplary bottom stereoscopic view of another angle of a seat mold according to an embodiment of the present invention, showing a third locating structure.

FIG. 6B illustrates an exemplary stereoscopic view of an upper mold of a main body mold according to an embodiment of the present invention, showing a fourth locating structure.

FIG. 6C illustrates an exemplary stereoscopic view of a left mold and a right mold of a main body mold according to an embodiment of the present invention, showing a first locating structure.

List of numerals in the figures:
110—Seat blank;
112—Bonding surface (of seat blank);
120—Inner container blank;
122—First bonding surface (of inner container blank);
124—Second bonding surface (of inner container blank);
130—Main body blank;
132—Bonding surface (of main body blank);
210—Seat mold;
212—Upper mold (of seat mold);
214—Bottom mold (of seat mold);
216—Third locating structure;
220—Inner container mold;
222—Upper mold (of inner container mold);
224—Bottom mold (of inner container mold);
226—Second locating structure;
230—Main body mold;
231—Upper mold (of main body mold);
232—Left mold (of main body mold);
233—Right mold (of main body mold);
234—Bottom mold (of main body mold);
236—First locating structure; and
238—Fourth locating structure.

### DETAILED DESCRIPTION

Unless otherwise defined, the technical terms used in the present invention shall have the usual meaning understood by those with general skills in the art to which the present invention belongs. Unless it is explicitly stated in the present invention that the steps should be performed in order, the words “first,” “second,” and the like used in this article do not indicate any sequence, quantity, or importance, but are only used to distinguish different components. In addition, the terms “upper,” “bottom,” “left,” “right,” and the like only represent relative positional relationships. When the absolute position of a described object changes, the relative positional relationships may also change accordingly.

In the present invention, the term “toilet” refers to the whole sanitary ware used for flushing, e.g., the sanitary ware includes a bowl with a sink, a toilet cover (e.g., an electronic or intelligent toilet cover, or a traditional toilet cover), and various pipelines, wires, connectors, accessories, and the like used in toilets. It can be understood that the toilets manufactured using a toilet blank of the present invention also cover various types of toilets, e.g., intelligent toilets, siphon toilets, and various types of traditional toilets, all of which are within the scope of the present invention.

The toilet blank manufactured by the manufacturing method of the present invention usually does not refer to a finished product of the aforementioned toilet, but usually refers to a bonded complete toilet blank (i.e., including a bowl and a seat), and such a toilet blank needs to be finely finished, assembled, and the like to become the finished product of a toilet.

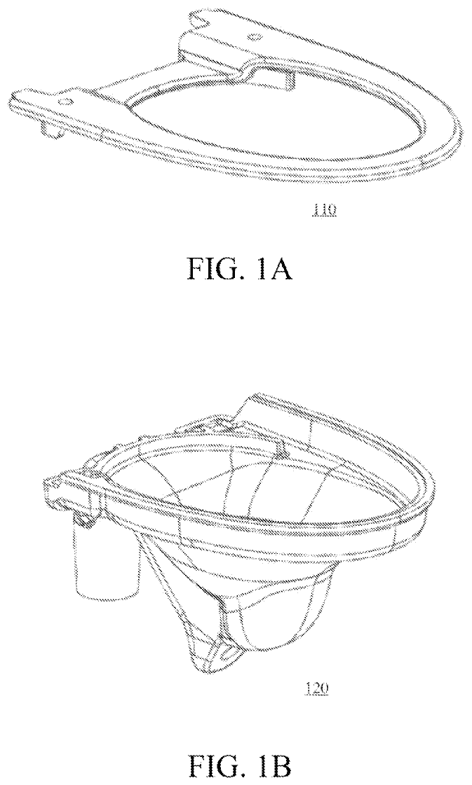

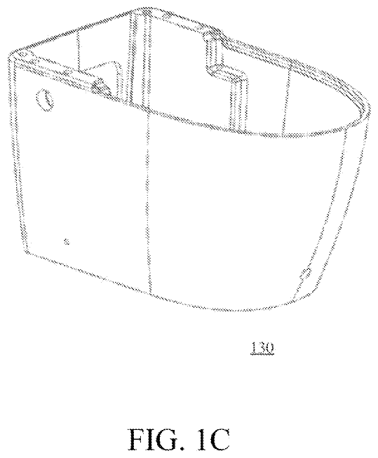

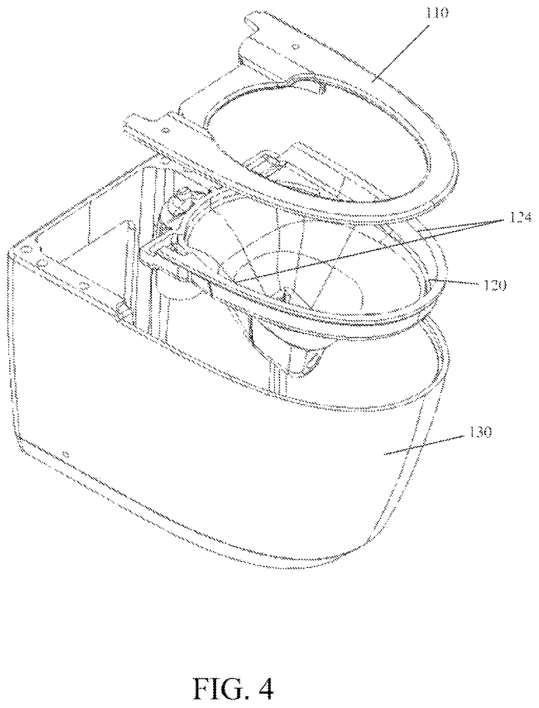

Overall, the present invention uses a separate three-blank structure, which can reduce the difficulty of mold structure design, facilitate production and processing, and save costs. By forming a main body blank 130 (i.e., the green body of a toilet bowl), an inner container blank 120 (the green body of a toilet inner container), and a seat blank 110 (the green body of a toilet seat) separately and independently (see FIGS. 1A-1C and FIG. 4), a cavity structure of a (e.g., ceramic) product may be effectively reduced, and deformation of the product during production may be effectively avoided, thereby improving the strength and production efficiency of the product. In addition, the separate three-blank mold structure is more simplified, and can effectively improve the processing efficiency, reduce the operational difficulty, and reduce human errors in a blank manufacturing process. In addition, in the present invention, due to use of the separate three-blank structure, the shape of the main body blank 130 may change flexibly to meet various requirements for the appearance of a toilet.

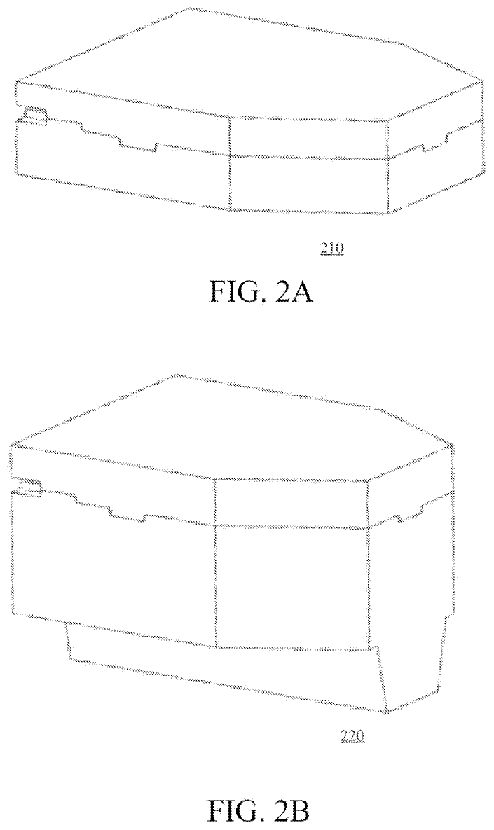

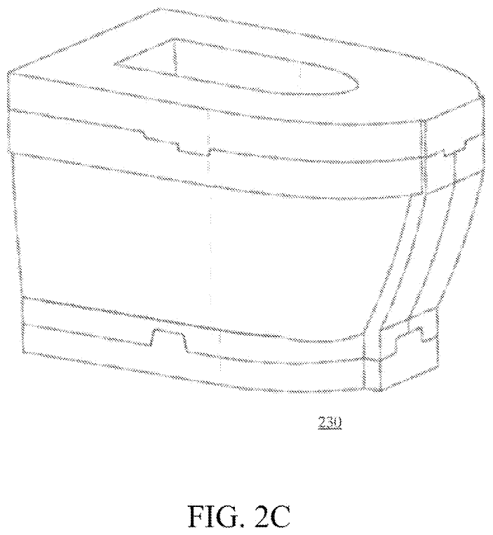

To this end, the present invention provides three types of molds for manufacturing a toilet blank, namely a seat mold 210, an inner container mold 220, and a main body mold 230 (for example, see FIGS. 2A-2C). How to form the molds is not the focus of the present invention, but in any case, these molds have the structure and hardness for forming the blanks, for example, the molds include elements well-known to those skilled in the art, e.g., runners, airways, parting surfaces, and draft angles.

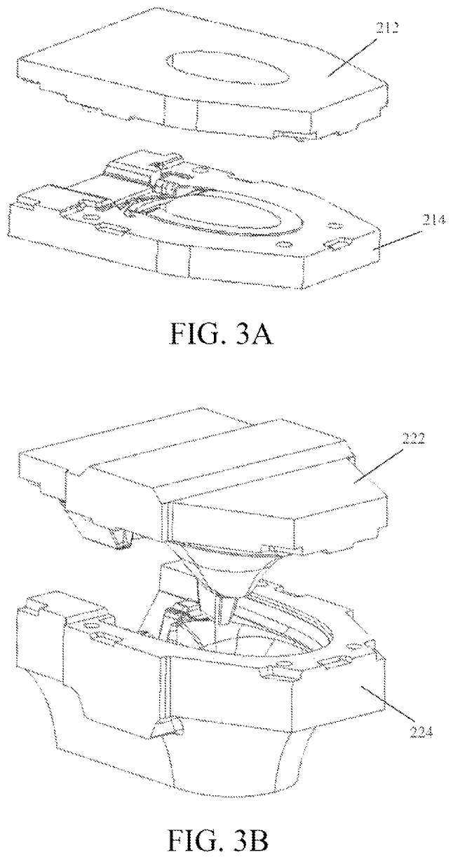

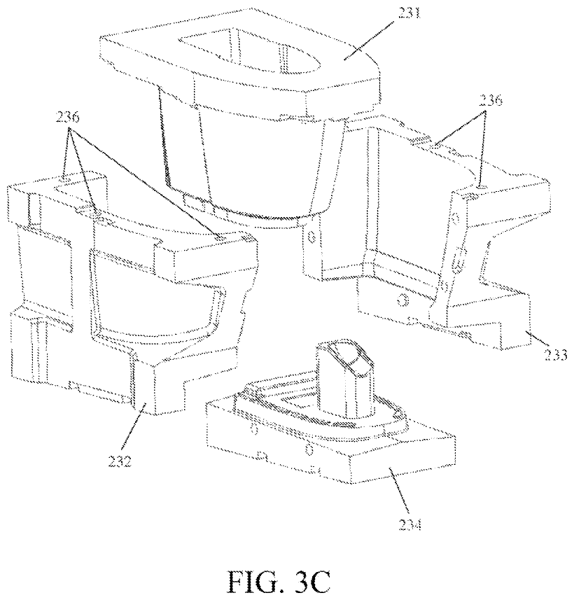

Favorably, the seat mold 210, the inner container mold 220, and the main body mold 230 may be non-integrated molds. In preferred embodiments shown in FIGS. 2A-2C and FIGS. 3A-3C, the seat mold 210 may be an upper and lower two-part mold, i.e., including an upper mold 212 and a bottom mold 214; the inner container mold 220 may also be an upper and lower two-part mold, i.e., including an upper mold 222 and a bottom mold 224, and the main body mold 230 may be a four-part mold, i.e., including an upper mold 231, a bottom mold 234, a left mold 232, and a right mold 233. However, it can be fully understood that these molds may not necessarily be divided into sub-mold parts as shown in the figures. For example, the main body mold 230 may also be a two-part mold, i.e., including an upper mold and a bottom mold, or may also be a three-part mold, i.e., including an upper mold, a bottom mold, and a side mold (an integrated side mold is not shown in the figure). Due to the fact that the seat mold 210, the inner container mold 220, and the main body mold 230 each include multiple sub-mold parts, the problems of large occupied area, low blank production efficiency, high blank repair dust, high mold cost, and the like of traditional molds used for toilet blanks are solved.

Preferably, the seat mold 210, the inner container mold 220, and the main body mold 230 are assembled and placed on a production line for grouting. Grouting may also be performed separately and sequentially, depending on the degree of automation of an existing production line. By grouting the seat mold 210, the inner container mold 220, and the main body mold 230 independent of each other respectively, the seat blank 110, the inner container blank 120, and the main body blank 130 are produced. After the grouting is completed and clay blanks in the molds are formed, the molds are demolded. The grouting process is not the focus of the present invention and thus will not be elaborated here.

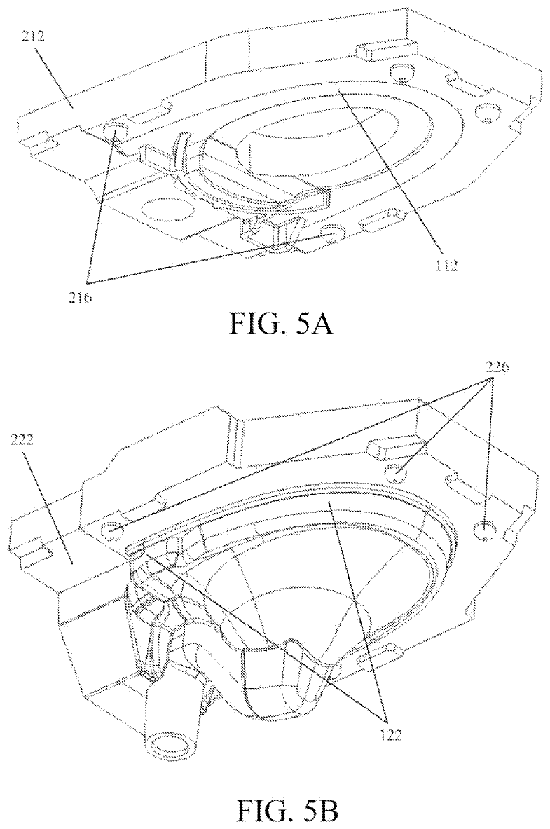

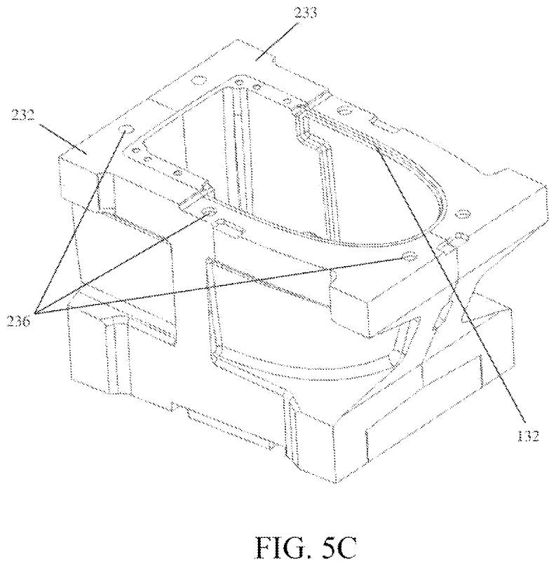

Firstly, a first demolding step is performed (here, “first” refers to the order of the demolding step). The first demolding step may include multiple sub-steps, e.g., demolding a part of the main body mold 230 from the main body blank 130 to expose a bonding surface 132 of the main body blank 130; demolding a part of the inner container mold 220 from the inner container blank 120 to expose a first bonding surface 122 of the inner container blank 120 (for example, see FIGS. 5A-SC); demolding a part of the seat mold 210 from the seat blank 110 to expose a bonding surface 112 of the seat blank 110; and the like. It can be understood that these sub-steps can be performed sequentially in the above order, or be performed in any other order, or even be performed or completed simultaneously without affecting subsequent processes.

Due to the fact that the seat mold 210, the inner container mold 220, and the main body mold 230 each include multiple sub-mold parts, the “parts of the molds” mentioned above refers to at least one of the multiple sub-mold parts to be demolded from each of the seat mold 210, the inner container mold 220, and the main body mold 230. In some preferred embodiments, the upper mold 231 of the main body mold 230 may be demolded from the main body blank 130 (the main body blank 130 with only the upper mold 231 demolded is shown in FIG. 5C), the bottom mold 224 of the inner container mold 220 may be demolded from the inner container blank 120 (the inner container blank 120 with only the bottom mold 224 demolded is shown in FIG. 5B), and the bottom mold 214 of the seat mold 210 may be demolded from the seat blank 110 (the seat blank 110 with only the bottom mold 214 demolded is shown in FIG. 5A).

Here, the term “bonding surface” refers to a surface on a blank for applying a bonding substance, e.g., bonding clay. Preferably, the bonding surface includes an at least partially flat surface, especially a complete plane, to facilitate formation, application, and bonding. However, the bonding surface being a curved surface or multiple planes containing steps is also within the scope of the protection of the present invention, depending on factors such as the size, type, and finished product structure of a toilet.

In a preferred embodiment, the bonding surface 132 of the main body blank 130 is at the top of the main body blank 130 (see FIG. 5C), i.e., the part covered by the upper mold 231 of the main body mold 230; the first bonding surface 122 of the inner container blank 120 is at the bottom of the inner container blank 120 (see FIG. 5B), i.e., the part covered by the bottom mold 224 of the inner container mold 220; a second bonding surface 124 of the inner container blank is at the top of the inner container blank 120 (see FIG. 4), i.e., the part covered by the upper mold 222 of the inner container mold 220; and the bonding surface 112 of the seat blank 110 is at the bottom of the seat blank 110 (see FIG. 5A), i.e., the part covered by the bottom mold 214 of the seat mold 210. However, the positions of the bonding surfaces are far from limited to the positions shown in the figures, for example, the bonding surfaces may also be oriented towards the center inner part of the toilet blank.

After the seat blank 110, the inner container blank 120, and the main body blank 130 reach a certain hardness respectively, the next process, i.e., the first bonding step (here, “first” refers to the order of the bonding step), is performed in a case that parts of the molds are still on the seat blank 110, the inner container blank 120, and the main body blank 130 (i.e., each not completely demolded but only partially demolded).

In the first bonding step, the first bonding surface 122 of the inner container blank 120 and the bonding surface 132 of the main body blank 130 are bonded to each other. For example, the first bonding step is performed by making the first bonding surface 122 of the inner container blank 120 and the bonding surface 132 of the main body blank 130 face each other and applying a bonding substance, e.g., bonding clay, to the bonding surfaces facing each other. In a preferred embodiment, the inner container mold 220 may be placed on the main body mold 230 to promote the first bonding surface 122 of the inner container blank 120 and the bonding surface 132 of the main body blank 130 to bond to each other. Here, the “inner container mold 220” and the “main body mold 230” both refer to the molds with parts (e.g., the bottom mold 224 of the inner container mold 220 and the upper mold 231 of the main body mold 230) demolded, rather than the complete original molds.

Especially favorably, after the bonding substance is applied to the first bonding surface 122 of the inner container blank 120 and the bonding surface 132 of the main body blank 130 respectively, the non-demolded part of the inner container mold 220 (e.g., the upper mold 222 of the inner container mold 220) may be placed on the non-demolded part of the main body mold 230 (e.g., the left mold 232 and the right mold 233 of the main body mold 230), to well locate the position using the non-demolded part of the inner container mold 220 and the non-demolded part of the main body mold 230 (the locating mode will be detailed below). At this point, the blanks remain in the non-demolded parts of the molds (i.e., the blanks with the molds are bonded).

After the first bonding step is completed, the inner container blank 120 and the main body blank 130 are bonded to each other. Then, the second demolding step is performed (here, the “second” refers to the order of the demolding step): another part of the inner container mold 220 is demolded from the inner container blank 120 to expose the second bonding surface 124 of the inner container blank 120 (for example, as shown in FIG. 4).

Preferably, the other part of the inner container mold 220 may be the upper mold 222 in the inner container mold 220 (see FIG. 5B), indicating that the second bonding surface 124 of the inner container blank 120 may be at the top. Especially, the second bonding surface 124 of the inner container blank 120 may be arranged roughly opposite to the first bonding surface 122. However, in a case that the inner container mold 220 is a multi-part mold, the second bonding surface of the inner container blank may also be arranged roughly opposite to other mold parts, depending on the position of the second bonding surface 124 of the inner container blank 120 to be bonded to the seat blank 110. Preferably, after the second demolding step is completed, no mold part remains on the inner container blank 120, that is, the inner container blank 120 is completely demolded from the mold. However, it may also be imagined that one or more mold parts still remain on the inner container blank 120, especially when the inner container mold 220 is a four-part mold.

After the second demolding step is completed, especially when the inner container blank 120 is completely demolded from the mold, excess bonding substances, such as those touchable from the outside, may be removed, or other cleaning works may be carried out.

After the second demolding step, the second bonding step may be performed (here, the “second” refers to the order of the bonding step): the bonding surface 112 of the seat blank 110 and the second bonding surface 124 of the inner container blank 120 are bonded to each other. In a preferred embodiment, the seat mold 210 may be placed on the main body mold 230 to promote the bonding surface 112 of the seat blank 110 and the bonding surface 132 of the main body blank 130 to bond to each other. Here, the “seat mold 210” and the “main body mold 230” both refer to the molds with parts (e.g., the bottom mold 214 of the seat mold 210 and the upper mold 231 of the main body mold 230) demolded, rather than the complete original molds. Preferably, the bonding surface 112 of seat blank 110 is on the bottom surface thereof, and the second bonding surface 124 of the inner container blank 120 is on the top surface thereof.

Especially favorably, after the bonding substance, e.g., bonding clay, is applied to the second bonding surface 124 of the inner container blank 120 and the bonding surface 112 of the seat blank 110 respectively, the non-demolded part of the seat mold 210 (e.g., the upper mold 212 of the seat mold 210, as shown in FIG. 5A) may be placed on the non-demolded part of the main body mold 230 (e.g., the left mold 232 and the right mold 233 of the main body mold 230, as shown in FIG. 5C), to well locate the position using the non-demolded part of the seat mold 210 and the non-demolded part of the main body mold 230 (the locating mode will be detailed below). At this point, the seat blank 110 and the main body blank 130 remain in the non-demolded parts of the molds (i.e., the blanks with the molds are bonded).

It can be understood that in both the first bonding step and the second bonding step, preferably, (the non-demolded part of) the inner container mold 220 and (the non-demolded part of) the seat mold 210 are placed on (the non-demolded part of) the main body mold 230, but other relative positions may also be imagined (for example, partially placed in the main body mold 230), mainly depending on the positions of the bonding surfaces on the blanks, usually in a manner conducive to mold location.

After the second bonding step is completed, an integral toilet blank including the seat blank 110, the inner container blank 120, and the main body blank 130 bonded together is formed. Therefore, after the second bonding step, the third demolding step is performed (here, the “third” refers to the order of the demolding step): the non-demolded parts of the seat mold 210, the inner container mold 220 (if there is still non-demolded part), and the main body mold 230 are demolded from the bonded toilet blank.

Preferably, the third demolding step is further subdivided into the following two sub-steps: the remaining mold parts (e.g., the upper mold 212) of the seat mold 210 are demolded (from the seat blank 110); and the remaining mold parts of the main body mold 230 are demolded (from the main body blank 130). Preferably, first the seat blank 110 is (finally) demolded, and then the main body blank 130 is (finally) demolded.

For example, after the second bonding step is completed, the remaining mold parts (e.g., the upper mold 212) of the seat mold 210 may be demolded from the seat blank 110, and excess bonding substances may be removed, or other cleaning works may be carried out. Before the main body blank 130 is (finally) demolded, other steps may be performed, for example, drilling holes in the entire toilet blank. However, it may also be imagined that first the main body mold 230 is finally demolded, and then the seat mold 210 is finally demolded.

After the main body blank 130 is (finally) demolded (i.e., the entire toilet blank is demolded), preferably, the toilet blank is placed on a tray and wiped and trimmed. Then, the toilet blank may be moved into a drying room and dried for a period of time. After drying, the toilet blank is glazed, and then the blank is loaded into a kiln and fired into a finished product (ceramic). These process steps are not the focus of the present invention and thus will not be elaborated here.

Regarding the relative location between the blanks, as mentioned earlier, in the first bonding step, before the inner container blank 120 and the main body blank 130 are bonded to each other, the relative position between the inner container blank 120 and the main body blank 130 may be favorably located using the non-demolded part (e.g., the upper mold 222) of the inner container mold 220 and the non-demolded part (e.g., the left mold 232 and the right mold 233) of the main body mold 230.

Similarly, in the second bonding step, before the inner container blank 120 and the seat blank 110 are bonded to each other, the relative position between the inner container blank 120 and the seat blank 110 may be favorably located using the non-demolded part (e.g., the upper mold 212) of the seat mold 210 and the non-demolded part (e.g., the left mold 232 and the right mold 233) of the main body mold 230.

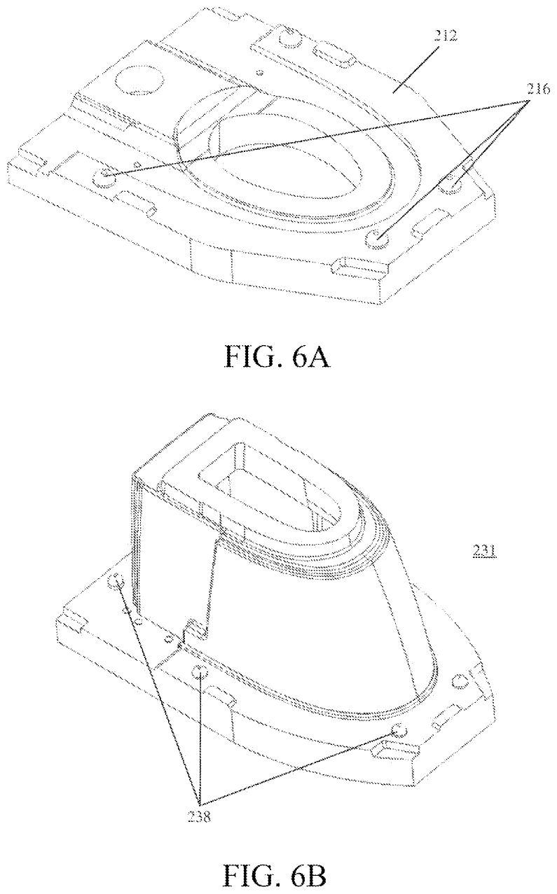

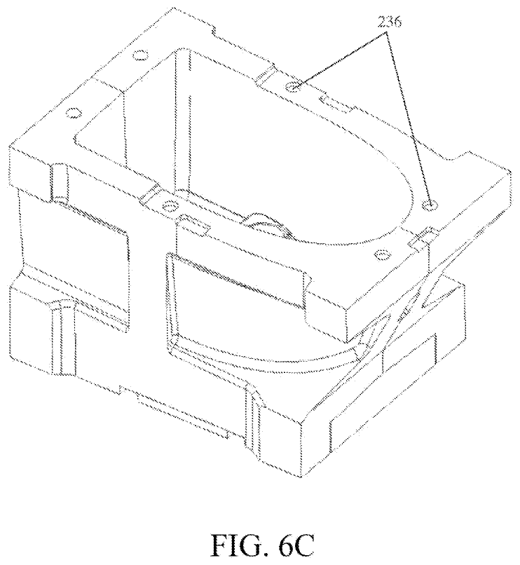

Locating structures arranged on the main body mold 230 and the inner container mold 220 respectively are shown in FIGS. 5B-5C and FIG. 6C. In this embodiment, a first locating structure 236 is arranged on the non-demolded part of the main body mold 230, e.g., the side molds (the left mold 232 and the right mold 233), and a second locating structure 226 and a third locating structure 216 that can match the first locating structure 236 in shape are arranged on the non-demolded part of the seat mold 210, e.g., the upper mold 212, and the non-demolded part of the inner container mold 220, e.g., the upper mold 222, respectively. Of course, as shown in FIG. 6B, a fourth locating structure 238 corresponding to the first locating structure 236 may also be arranged on the upper mold 231 of the main body mold 230.

In some embodiments, the first locating structure 236 may include at least one locating hole, and the second locating structure 226 and the third locating structure 216 each may include at least one corresponding locating detent (see FIGS. SA-5B and FIG. 6A). Alternatively, the first locating structure 236 may include at least one locating detent or locating column, and the second locating structure 226 and the third locating structure 216 each may include at least one corresponding locating hole. In FIGS. 5C and 6C, six locating holes on the left mold 232 and the right mold 233 of the main body mold 230 are shown, while in FIGS. 5A-5B, four locating detents on the upper mold 212 of the seat mold 210 and the upper mold 222 of the inner container mold 220 are shown. However, the specific number and layout of these holes are not limited, and any suitable number and position may be used.

Although in the present invention, the locating structures are preferably matching structures matched in shape, especially locating structures arranged facing each other, the locating structures of the present invention are not limited to this, for example, the locating structures may also be locating structures arranged on at least one of the lateral two sides of the non-demolded parts of the molds, or other matching structures.

In the first bonding step, due to the fact that the second locating structure 226 on the non-demolded part of the inner container mold 220 can match and be connected into the first locating structure 236 on the non-demolded part of the main body mold 230 (e.g., the locating detents arranged on the upper mold 222 of the inner container mold 220 can be connected into the locating holes on the left mold 232 and the right mold 233 of the main body mold 230), the inner container blank 120 and the main body blank 130 may be accurately located simply by closing the two mold parts to obtain the best bonding effect.

In the second bonding step, due to the fact that the third locating structure 216 on the non-demolded part of the seat mold 210 can match and be connected into the first locating structure 236 on the non-demolded part of the main body mold 230 (e.g., the locating detents arranged on the upper mold 212 of the seat mold 210 can be connected into the locating holes on the left mold 232 and the right mold 233 of the main body mold 230), the seat blank 110 and the inner container blank 120 (already bonded to the main body blank 130) may be accurately located simply by closing the two mold parts to obtain the best bonding effect.

Due to the fact that all the blanks are bonded to each other with the molds not demolded, the contact of an operator with the blanks is reduced during bonding, thereby lowering the scrap rate of the blanks caused by contact. In addition, since locating is assisted by use of the locating structures on the molds, the accuracy of position during bonding with the molds is significantly improved. Furthermore, the possibility of improving the degree of automation in manufacturing blanks is increased, and the manufacturing cost may be decreased.

Although various embodiments of the present invention are described with reference to the embodiments of a toilet with three separate blanks in the accompanying drawings, it should be understood that the embodiments within the scope of the present invention may be applied to sanitary ware with similar structures (e.g., a toilet with four blanks or five blanks) and/or sanitary ware with similar functions (e.g., sanitary ware other than toilets, such as urinals and bathtubs).

The previous description has provided many features and advantages, including various alternative embodiments, as well as details of the structures and functions of devices and methods. This description is intended for illustration rather than exhaustion or restriction.

For those skilled in the art, it is evident that various modifications may be made in the entire scope indicated by the broad upper meaning of the terms expressed in the attached claims, especially in terms of structures, materials, elements, components, shapes, dimensions, and arrangement of components, including combinations of these aspects in the scope of the principles described here. The various modifications that do not deviate from the spirit and scope of the attached claims are also included in this article.

1. A method for manufacturing a toilet blank, the manufacturing method comprising the following steps:
a grouting step: grouting a seat mold (210), an inner container mold (220), and a main body mold (230) independent of each other respectively to produce a seat blank (110), an inner container blank (120), and a main body blank (130);
a first demolding step: demolding a part of the main body mold (230) from the main body blank (130) to expose a bonding surface (132) of the main body blank (130); demolding a part of the inner container mold (220) from the inner container blank (120) to expose a first bonding surface (122) of the inner container blank (120); and demolding a part of the seat mold (210) from the seat blank (110) to expose a bonding surface (112) of the seat blank (110);
a first bonding step: placing the inner container mold (220) on the main body mold (230) to bond the first bonding surface (122) of the inner container blank (120) and the bonding surface (132) of the main body blank (130) to each other;
a second demolding step: demolding another part of the inner container mold (220) from the inner container blank (120) to expose a second bonding surface (124) of the inner container blank (120);
a second bonding step: placing the seat mold (210) on the inner container mold (220) to bond the bonding surface (112) of the seat blank (110) and the second bonding surface (124) of the inner container blank (120) to each other; and
a third demolding step: demolding non-demolded parts of the seat mold (210), the inner container mold (220), and the main body mold (230) from a bonded toilet blank,
wherein the sub-steps in the first demolding step can be performed in any order, and after the first demolding step is performed, the first bonding step, the second demolding step, the second bonding step, and the third demolding step are sequentially performed.

2. The method for manufacturing a toilet blank according to claim 1, wherein in the first demolding step, an upper mold (231) of the main body mold (230) is demolded from the main body blank (130), a bottom mold (224) of the inner container mold (220) is demolded from the inner container blank (120), and a bottom mold (214) of the seat mold (210) is demolded from the seat blank (110).

3. The method for manufacturing a toilet blank according to claim 2, wherein the third demolding step comprises: demolding an upper mold (212) of the seat mold (210) from the seat blank (110); and demolding the remaining molds of the main body mold (230) from the main body blank (130).

4. The method for manufacturing a toilet blank according to claim 3, wherein in the first bonding step, before the inner container blank (120) and the main body blank (130) are bonded to each other, the relative position between the inner container blank (120) and the main body blank (130) is located using the non-demolded part of the inner container mold (220) and the non-demolded part of the main body mold (230).

5. The method for manufacturing a toilet blank according to claim 3, wherein in the second bonding step, before the inner container blank (120) and the seat blank (110) are bonded to each other, the relative position between the inner container blank (120) and the seat blank (110) is located using the non-demolded part of the seat mold (210) and the non-demolded part of the main body mold (230).

6. The method for manufacturing a toilet blank according to claim 4 or 5, wherein the main body mold (230) at least comprises an upper mold (231) and a side mold, and in the first bonding step and the second bonding step, the relative position between the inner container blank (120) and the main body blank (130), as well as the relative position between the inner container blank (120) and the seat blank (110) is located using the side mold of the main body mold (230).

7. The method for manufacturing a toilet blank according to claim 6, wherein a first locating structure (236) is arranged on the side mold of the main body mold (230), and a second locating structure (226) and a third locating structure (216) that can match the first locating structure (236) in shape are arranged on an upper mold (222) of the inner container mold (220) and the upper mold (212) of the seat mold (210) respectively.

8. The method for manufacturing a toilet blank according to claim 7, wherein the first locating structure (236) comprises at least one locating hole, and the second locating structure (226) and the third locating structure (216) comprise at least one locating detent corresponding to the at least one locating hole.

9. The method for manufacturing a toilet blank according to claim 6, wherein between the sub-steps of the third demolding step, holes are drilled on the toilet blank.

10. A toilet blank, manufactured by the manufacturing method according to any one of claims 1-9.
